(19) United States
(12) Patent Application Publication
(10) Pub. No.: US 2025/0097983 A1
(43) Pub. Date: Mar. 20, 2025

(54) RANDOM ACCESS PROCEDURES

(71) Applicant: QUALCOMM Incorporated, San Diego, CA (US)

(72) Inventors: Jing LEI, San Diego, CA (US); Kazuki TAKEDA, Tokyo (JP); Kianoush HOSSEINI, San Diego, CA (US)

(21) Appl. No.: 18/470,982

(22) Filed: Sep. 20, 2023

(51) Int. Cl. H04W 74/08; H04L 1/1812; H04W 74/00

(52) U.S. Cl. CPC H04W 74/0833; H04L 1/1812; H04W 74/006

(57) ABSTRACT

Various aspects of the present disclosure generally relate to wireless communication. In some aspects, a user equipment (UE) may receive a physical downlink control channel (PDCCH) message indicating initiation of a random access procedure, the PDCCH message having a dedicated format with a set of fields for indicating one or more parameters associated with the initiation of the random access procedure. The UE may transmit a first random access message of the random access procedure, the first random access message being associated with the one or more parameters. Numerous other aspects are described.

### FIELD OF THE DISCLOSURE

Aspects of the present disclosure generally relate to wireless communication and specifically relate to techniques, apparatuses, and methods for performing random access procedures.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (V2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a physical downlink control channel (PDCCH) message indicating initiation of a random access procedure, the PDCCH message having a dedicated format with a set of fields for indicating one or more parameters associated with the initiation of the random access procedure. The method may include transmitting a first random access message of the random access procedure, the first random access message being associated with the one or more parameters.

Some aspects described herein relate to a method of wireless communication performed by a network node. The method may include transmitting a PDCCH message indicating initiation of a random access procedure, the PDCCH message having a dedicated format with a set of fields for indicating one or more parameters associated with the initiation of the random access procedure. The method may include receiving a first random access message of the random access procedure, the first random access message being associated with the one or more parameters.

Some aspects described herein relate to a UE for wireless communication. The UE may include one or more memories and one or more processors coupled to the one or more memories. The one or more processors, individually or collectively, may be configured to receive a PDCCH message indicating initiation of a random access procedure, the PDCCH message having a dedicated format with a set of fields for indicating one or more parameters associated with the initiation of the random access procedure. The one or more processors, individually or collectively, may be configured to transmit a first random access message of the random access procedure, the first random access message being associated with the one or more parameters.

Some aspects described herein relate to a network node for wireless communication. The network node may include one or more memories and one or more processors coupled to the one or more memories. The one or more processors, individually or collectively, may be configured to transmit a PDCCH message indicating initiation of a random access procedure, the PDCCH message having a dedicated format with a set of fields for indicating one or more parameters associated with the initiation of the random access procedure. The one or more processors, individually or collectively, may be configured to receive a first random access message of the random access procedure, the first random access message being associated with the one or more parameters.

Some aspects described herein relate to a non-transitory computer-readable medium that stores a set of instructions for wireless communication by a UE. The set of instructions, when executed by one or more processors of the UE, may cause the UE to receive a PDCCH message indicating initiation of a random access procedure, the PDCCH message having a dedicated format with a set of fields for indicating one or more parameters associated with the initiation of the random access procedure. The set of instructions, when executed by one or more processors of the UE, may cause the UE to transmit a first random access message of the random access procedure, the first random access message being associated with the one or more parameters.

Some aspects described herein relate to a non-transitory computer-readable medium that stores a set of instructions for wireless communication by a network node. The set of instructions, when executed by one or more processors of the network node, may cause the network node to transmit a PDCCH message indicating initiation of a random access procedure, the PDCCH message having a dedicated format with a set of fields for indicating one or more parameters associated with the initiation of the random access procedure. The set of instructions, when executed by one or more processors of the network node, may cause the network node to receive a first random access message of the random access procedure, the first random access message being associated with the one or more parameters.

Some aspects described herein relate to an apparatus for wireless communication. The apparatus may include means for receiving a PDCCH message indicating initiation of a random access procedure, the PDCCH message having a dedicated format with a set of fields for indicating one or more parameters associated with the initiation of the random access procedure. The apparatus may include means for transmitting a first random access message of the random access procedure, the first random access message being associated with the one or more parameters.

Some aspects described herein relate to an apparatus for wireless communication. The apparatus may include means for transmitting a PDCCH message indicating initiation of a random access procedure, the PDCCH message having a dedicated format with a set of fields for indicating one or more parameters associated with the initiation of the random access procedure. The apparatus may include means for receiving a first random access message of the random access procedure, the first random access message being associated with the one or more parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of carrier aggregation, in accordance with the present disclosure.

FIG. 5 is a diagram illustrating an example of a two-step random access procedure, in accordance with the present disclosure.

FIG. 6 is a diagram illustrating an example of a four-step random access procedure, in accordance with the present disclosure.

FIGS. 7A and 7B are diagrams illustrating an example associated with random access procedures, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some communications systems, a user equipment (UE) can access communication resources across a plurality of different bands to achieve a higher throughput than the UE can achieve in a single band. For example, in carrier aggregation (CA)-enabled communications systems, a UE may be assigned first communication resources in a first bandwidth, second communication resources in a second bandwidth, and/or third communication resources in a third bandwidth, among other examples. Each bandwidth may be associated with one or more cells, such as a primary cell (PCell), a secondary cell (SCell), or a primary secondary cell (PSCell), among other examples. A network node and a UE may initiate a physical downlink control channel (PDCCH) ordered physical random access channel (PRACH) transmission on an SCell to obtain a timing advance for a secondary timing advance group (sTAG). After a PRACH transmission on the SCell, the UE may be configured to switch to a PCell to monitor for a type-1 PDCCH common search space (CSS) set, to decode a random access response (RAR) (e.g., if scheduling information for the RAR has been detected), or to transmit a hybrid automatic repeat request (HARQ) acknowledgment (ACK) (e.g., if RAR decoding has been successful).

Resources for random access channel communications may be configured on an SCell or a PCell. However, if the SCell is not a scheduling cell for the UE, the UE may not successfully receive a PDCCH message, from a PCell, that is to trigger the UE to transmit a PRACH communication on the SCell. Additionally, or alternatively, the UE may not be configured to transmit an early report or an assistance information message during a random access procedure to enable a network node to configure energy saving or traffic offloading techniques. Additionally, or alternatively, when random access search space sets and physical uplink control channel (PUCCH) resources associated with one or more SCells are only configured on a PCell, the UE and the network node may lack scheduling flexibility.

Some aspects described herein provide random access procedures for carrier aggregation (CA), dual-connectivity (DC), and/or dual subscriber information module (SIM) (dual-SIM or DS) scenarios. For example, a network node may configure a UE such that a PCell can be included in either a master cell group (MCG) or a secondary cell group (SCG), and the network node may configure resources on a PCell for a supplementary link or a non-supplementary link. In some aspects, the UE may initiate a random access procedure on an SCell based on receiving a PDCCH from the network node using configured resources. In some aspects, the PDCCH may be associated with downlink control information (DCI) with a particular format for requesting or ordering performing of a random access procedure. In some aspects, a set of triggering events may be configured for causing the UE to initiate the random access procedure. In this way, by providing the random access procedures, the UE and the network node may improve flexibility and may enable use of CA, DC, or DS techniques. By enabling use of CA, DC, or DS techniques, the UE and the network node may improve throughput and/or improve reliability of communications.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

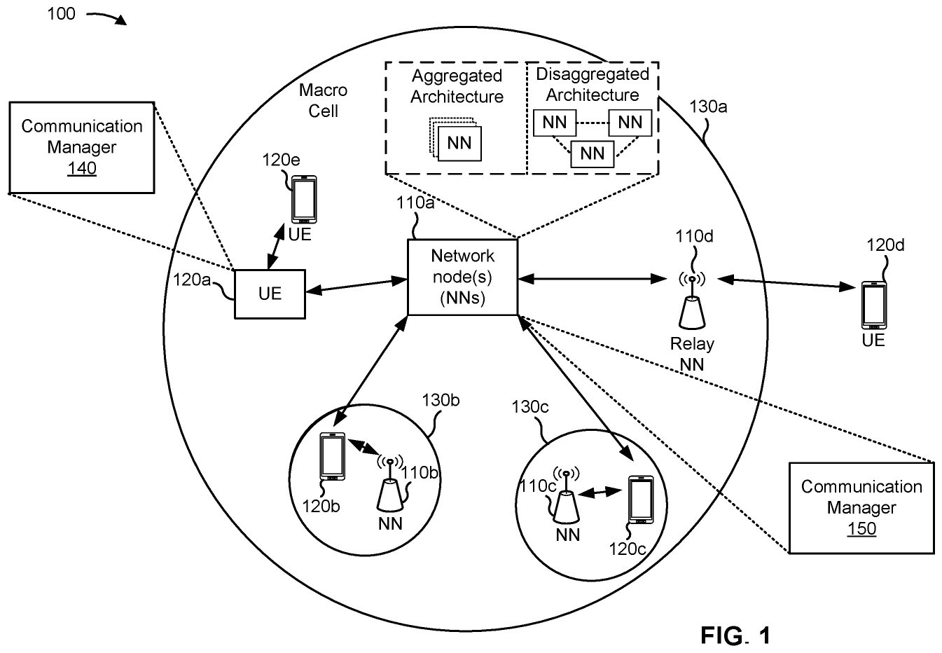

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components or systems that enable communication between a UE 120 and one or more devices, components or systems of the wireless communication network 100. A network node 110 may be, may include, or may also be referred to as, an NR network node, a 5G network node, a 6G network node, a Node B, an eNB, a gNB, an access point (AP), a transmission reception point (TRP), a mobility element, a core, a network entity, a network element, a network equipment, and/or another type of device, component or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node, meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The IAB donor 110 may connect to the core network via a wired backhaul link. For example, an Ng interface of the IAB donor 110 may terminate at the core network. Additionally or alternatively, an IAB donor 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each IAB node 110 may communicate directly with the IAB donor 110 via a wireless backhaul link to access the core network, or may communicate indirectly with the IAB donor 110 via one or more other IAB nodes 110 and associated wireless backhaul links that form a backhaul path to the core network. Some IAB donors 110 or other IAB nodes 110 may also communicate directly with one or more UEs 120 via wireless access links that carry access traffic. In some examples, network resources for wireless communication (such as time resources, frequency resources, and/or spatial resources) may be shared between access links and backhaul links.

An IAB donor 110 may include a CU, which may perform access node controller (ANC) functions and/or AMF functions. The CU may configure a DU of the IAB donor 110 and/or may configure one or more IAB nodes 110 (for example, a mobile termination (MT) function and/or a DU function of each of the IAB nodes) that connect to the core network via the IAB donor 110. Thus, a CU of an IAB donor 110 may control and/or configure the entire IAB network (or a portion thereof) that connects to the core network via the IAB donor 110, such as by using control messages and/or configuration messages (for example, an RRC configuration message or an F1 application protocol (F1AP) message).

An IAB node 110 other than an IAB donor 110 also may control and/or schedule communications for a second IAB node 110 (for example, when the IAB node provides DU functions for the MT functions of the second IAB node). In such deployments, the first IAB node 110 may be referred to as a parent IAB node of the second IAB node 110, and the second IAB node 110 may be referred to as a child IAB node of the first IAB node 110. Similarly, a child IAB node of the second IAB node 110 may be referred to as a grandchild IAB node of the first IAB node 110. A DU function of a parent IAB node may control and/or schedule communications for child IAB nodes of the parent IAB node. In some examples, a DU function may exercise limited control over communications of a grandchild node, such as via indication of soft resources or restricted beams at a child node associated with the grandchild node. In some examples, an IAB node 110 that implements a DU function may be referred to as a scheduling node or a scheduling component, and an IAB node 110 that implements an MT function may be referred to as a scheduled node or a scheduled component.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

In some examples, a relay network node 110 may include an electromagnetic radiation reflective component that can be used to relay (for example, reflect) signals from a first other network node 110 to a second other network node 110 or a UE 120. Such a relay network node 110 can include, for example, a radio frequency reflection array configured to perform radio frequency reflection functions. The electromagnetic radiation reflective array can be, for example, a reconfigurable intelligent surface (RIS) (which also can be referred to as an intelligent reflective surface (IRS)).

As indicated above, a network node 110 may be a terrestrial network node 110 (for example, a terrestrial base station or entity of a disaggregated base station) or an NTN network node 110. For example, the wireless communication network 100 may include one or more NTN deployments including a non-terrestrial network node, an NTN network node 110, and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120, other NTN network nodes 110 in the one or more NTN deployments, other types of network nodes 110 (for example, stationary, terrestrial, and/or ground-based network nodes), relay stations, and/or one or more components and/or devices included in or coupled with a core network of the wireless communication network 100. For example, an NTN network node 110 may communicate with a UE 120 via a service link (for example, where the service link includes an access link). Additionally or alternatively, an NTN network node 110 may communicate with a gateway (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). An NTN deployment may be transparent (for example, where the NTN network node 110 operates in a similar manner as a repeater or relay and/or where an access link does not terminate at the NTN network node 110) or regenerative (for example, where the NTN network node 110 regenerates a signal and/or where an access link terminates at the NTN network node 110).

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements but not second device or performance requirements (such as parameters specified for NR UEs 120 other than UEs 120 of the third category), while a UE 120 of the second category (a mission-critical IoT UE or a premium UE) may have capabilities that satisfy the second device or performance requirements (and also the first device or performance requirements, in some examples). For example, a UE 120 of the third category may support a lower maximum modulation and coding scheme (MCS) (for example, a modulation scheme such as quadrature phase shift keying (QPSK)) than an MCS supported by a UE 120 of the second category (for example, a modulation scheme such as 256-quadrature amplitude modulation (QAM)). As another example, a UE of the third category may support a lower maximum transmit power than a maximum transmit power of a UE of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum BWP as a UE 120 of the second category.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some examples, a UE 120 may implement power saving features, such as for UEs 120 in an RRC connected mode, an RRC idle mode, or an RRC inactive mode. Power saving features may include, for example, relaxed radio resource monitoring (such as for devices operating in low mobility or in good radio conditions), discontinuous reception (DRX), reduced PDCCH monitoring during active times, and/or power-efficient paging reception.

In some examples, a UE 120 may operate in association with a DRX configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state, and one or more durations during which the UE 120 may operate in an inactive state, which may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. Conversely, if the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some aspects, the UE 120 may include a communication manager 140. As described in more detail elsewhere herein, the communication manager 140 may receive a PDCCH message indicating initiation of a random access procedure, the PDCCH message having a dedicated format with a set of fields for indicating one or more parameters associated with the initiation of the random access procedure; and transmit a first random access message of the random access procedure, the first random access message being associated with the one or more parameters. Additionally, or alternatively, the communication manager 140 may perform one or more other operations described herein.

In some aspects, the network node 110 may include a communication manager 150. As described in more detail elsewhere herein, the communication manager 150 may transmit a PDCCH message indicating initiation of a random access procedure, the PDCCH message having a dedicated format with a set of fields for indicating one or more parameters associated with the initiation of the random access procedure; and receive a first random access message of the random access procedure, the first random access message being associated with the one or more parameters. Additionally, or alternatively, the communication manager 150 may perform one or more other operations described herein.

As indicated above, FIG. 1 is provided as an example. Other examples may differ from what is described with regard to FIG. 1.

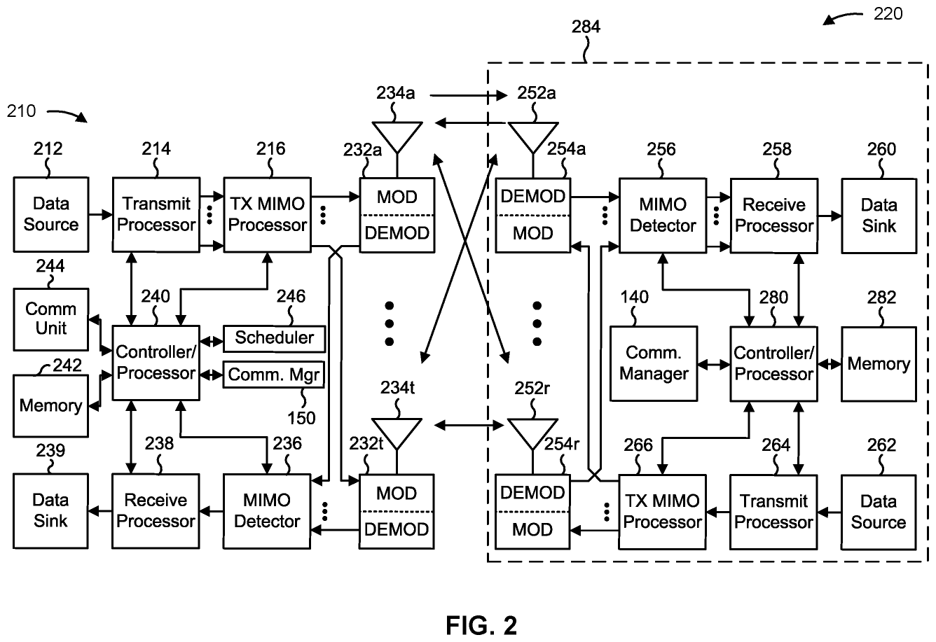

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) multiple-input multiple-output (MIMO) processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150 among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 210 may include transmit processor 214, TX MIMO processor 216, MIMO detector 236, receive processor 238, and/or controller/processor 240. Similarly, one or more processors of the UE 220 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface, such as a network interface.

The UE 220 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220. The transceiver may be under control of and used by a processor, such as the controller/processor 280, and in some aspects in conjunction with processor-readable code stored in the memory 282, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to the data sink 260 (such as a data pipeline, a data queue, and/or an application executed on the UE 220), and may provide decoded control information and system information to the controller/processor 280.

For uplink communication from the UE 220 to the network node 210, the transmit processor 264 may receive and process data (“uplink data”) from a data source 262 (such as a data pipeline, a data queue, and/or an application executed on the UE 220) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals (for example, R uplink signals) via the corresponding set of antennas 252. An uplink signal may include an uplink control information (UCI) communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 110 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

The network node 210 may provide the UE 220 with a configuration of transmission configuration indicator (TCI) states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-ResourceId or an SSB-Index, among other examples). Spatial relation information may similarly indicate information associated with an uplink beam. The beam indication may be a joint or separate DL/UL beam indication in a unified TCI framework. In a unified TCI framework, the network may support common TCI state ID update and activation, which may provide common QCL and/or common UL transmission spatial filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support a layer 1 (L1)-based beam indication using at least UE-specific (unicast) DCI to indicate joint or separate DL/UL beam indications that may be selected from active TCI states. In some examples, DCI formats 1_1 and/or 1_2 may be used for beam indication. The network node 210 may include a support mechanism for the UE 220 to acknowledge successful decoding of a beam indication. For example, the acknowledgment/negative acknowledgment of the PDSCH scheduled by the DCI carrying the beam indication may also be used as an acknowledgement for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam to communicate with the UE 220 when the UE 220 is in motion because wider coverage may increase the likelihood that the UE 220 remains in coverage of the network node 210 while moving. Conversely, the network node 210 may use a narrower beam to communicate with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the network node 210 may transmit a reference signal, such as a synchronization signal block (SSB) or a channel state information reference signal (CSI-RS), on each of a plurality of beams in a beam-sweeping manner. In some examples, SSBs may be transmitted on wider beams, whereas CSI-RSs may be transmitted on narrower beams. The UE 220 may measure the RSRP or the signal-to-interference-plus-noise ratio (SINR) on each of the beams and transmit a beam measurement report (for example, an L1 measurement report) to the network node 210 indicating the RSRP or SINR associated with each of one or more of the measured beams. The network node 210 may then select the particular beam for communication with the UE 220 based on the L1 measurement report. In some other examples, when there is channel reciprocity between the uplink and the downlink, the network node 210 may derive the particular beam to communicate with the UE 220 (for example, on both the uplink and downlink) based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a medium access control (MAC) control element (MAC-CE) for L2 signaling), rather than semi-static Layer 3 (L3) RRC signaling, in order to reduce latency, reduce overhead, and/or otherwise increase efficiency of the cell switch.

In some examples, for a UE 220, UL transmission may be performed using one antenna panel, and DL reception may be performed using another antenna panel. In some examples, full-duplex communication may be conditional on a beam separation of the UL beam and DL beam at respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable more efficient utilization of resources. Beam separation of the UL and DL beams assists in limiting or reducing self-interference that may occur during full duplex communication. UL and DL beams that are separated on their respective antenna panels may provide reliable full duplex communication by minimizing or reducing self-interference.

A full-duplex UE 220 may perform a self-interference measurement (SIM) procedure to identify self-interference from transmissions of the full-duplex UE 220. A full-duplex network node 210 also may perform a SIM procedure to identify self-interference from transmissions of the full-duplex network node 210. The UE 220 may provide a measurement report to the network node 210 to indicate results of the UE SIM. The network node 210 may select pairs of beams (referred to herein as “beam pairs”) for the UE 220 (“UE beam pairs”) and the network node 210 (“network node beam pairs”) to use during full-duplex communications. A beam pair generally includes a receive (Rx) beam and a transmit (Tx) beam, such as a DL beam and an UL beam, respectively, for the UE 220, and similarly, an UL beam and a DL beam, respectively, for the network node 210.

As indicated above, FIG. 2 is provided as an example. Other examples may differ from what is described with regard to FIG. 2.

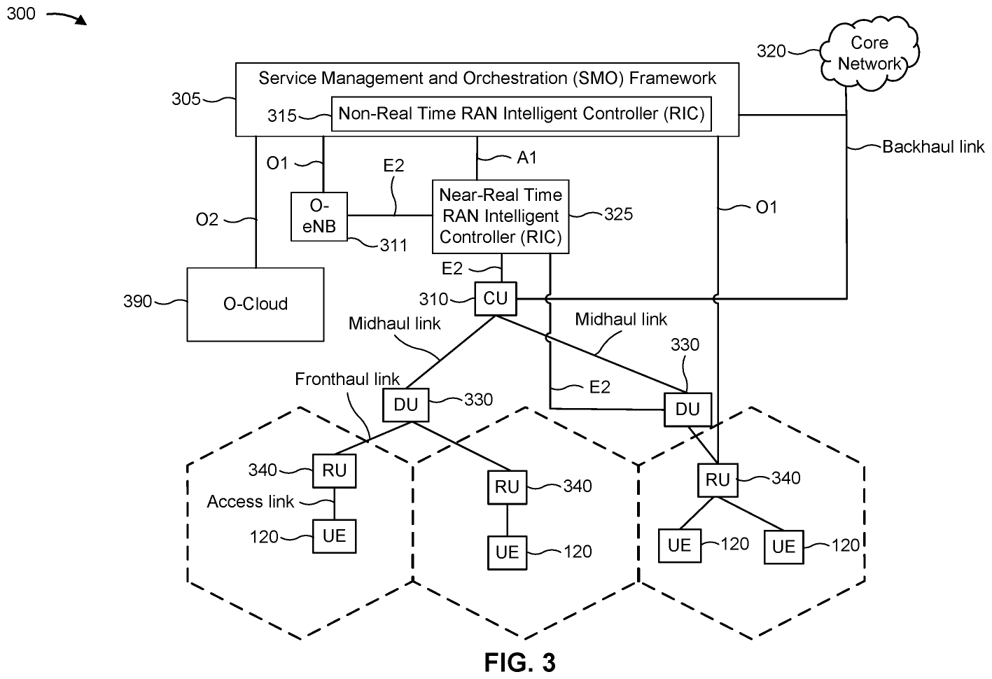

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110 or one or more network nodes 210). The disaggregated base station architecture 300 may include a CU 310 that can communicate directly with a core network 320 via a backhaul link, or that can communicate indirectly with the core network 320 via one or more disaggregated control units, such as a Near-RT RIC 325 (for example, via an E2 link) and/or a Non-RT RIC 315 associated with a Service Management and Orchestration (SMO) Framework 305. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 325, the Non-RT RICs 315, and the SMO Framework 305, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 305 may support RAN deployment and provisioning of non-virtualized and virtualized network elements. For non-virtualized network elements, the SMO Framework 305 may support the deployment of dedicated physical resources for RAN coverage requirements, which may be managed via an operations and maintenance interface, such as an O1 interface. For virtualized network elements, the SMO Framework 305 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 315, and/or a Near-RT RIC 325. In some aspects, the SMO Framework 305 may communicate with a hardware aspect of a 4G RAN, a 5G NR RAN, and/or a 6G RAN, such as an open eNB (O-eNB) 311, via an O1 interface. Additionally or alternatively, the SMO Framework 305 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 315 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 325. The Non-RT RIC 315 may be coupled to or may communicate with (such as via an A1 interface) the Near-RT RIC 325. The Near-RT RIC 325 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 325.

In some aspects, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may tune RAN behavior or performance. For example, the Non-RT RIC 315 may monitor long-term trends and patterns for performance and may employ AI/ML models to perform corrective actions via the SMO Framework 305 (such as reconfiguration via an O1 interface) or via creation of RAN management policies (such as A1 interface policies).

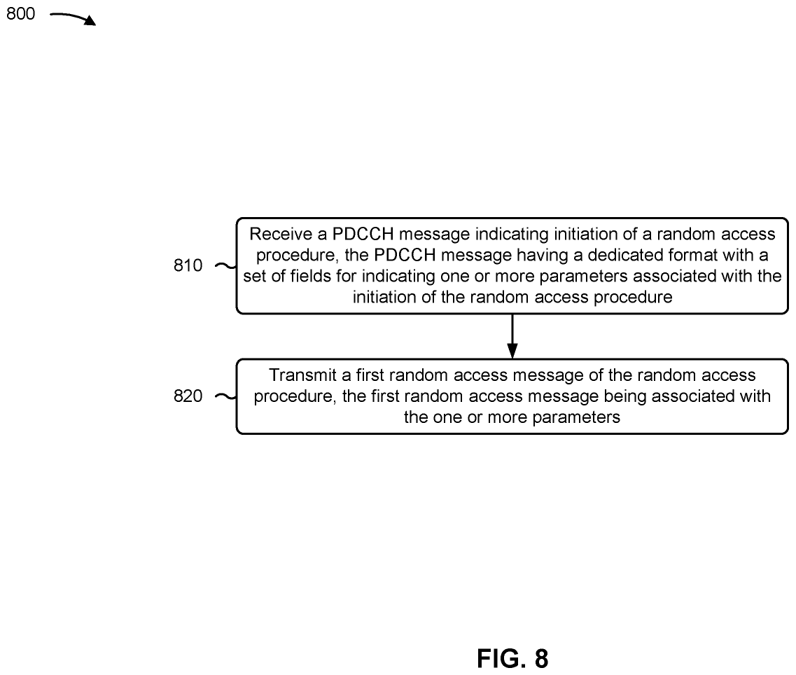

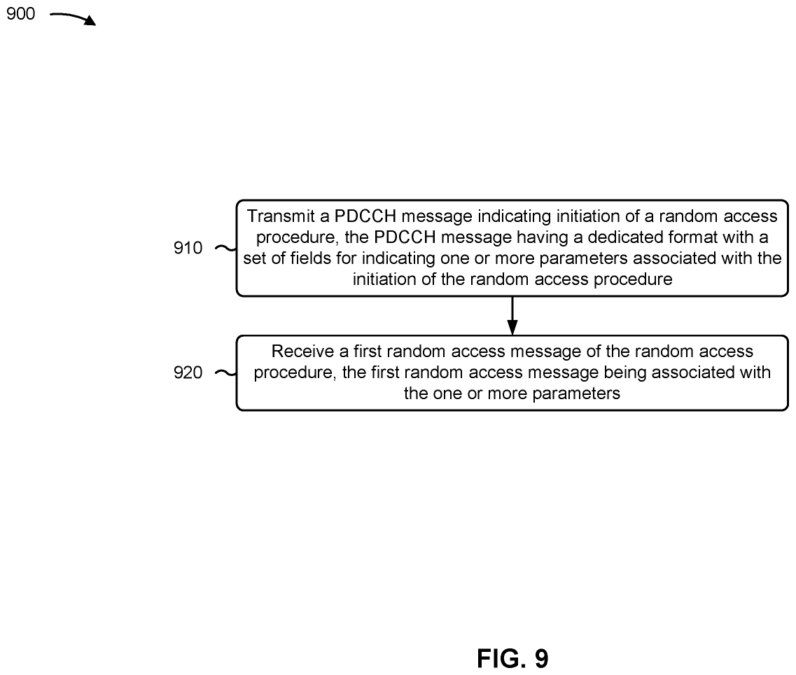

The network node 110, the controller/processor 240 of the network node 210, the UE 120, the controller/processor 280 of the UE 220, the CU 310, the DU 330, the RU 340, or any other component(s) of FIG. 1, 2, or 3 may implement one or more techniques or perform one or more operations associated with random access procedure, as described in more detail elsewhere herein. For example, the controller/processor 240 of the network node 210, the controller/processor 280 of the UE 220, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 210, the CU 310, the DU 330, or the RU 340. The memory 282 may store data and program codes for the UE 120 or the UE 220. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210, the UE 220, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE 120 includes means for receiving a PDCCH message indicating initiation of a random access procedure, the PDCCH message having a dedicated format with a set of fields for indicating one or more parameters associated with the initiation of the random access procedure; and/or means for transmitting a first random access message of the random access procedure, the first random access message being associated with the one or more parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for transmitting a PDCCH message indicating initiation of a random access procedure, the PDCCH message having a dedicated format with a set of fields for indicating one or more parameters associated with the initiation of the random access procedure; and/or means for receiving a first random access message of the random access procedure, the first random access message being associated with the one or more parameters. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

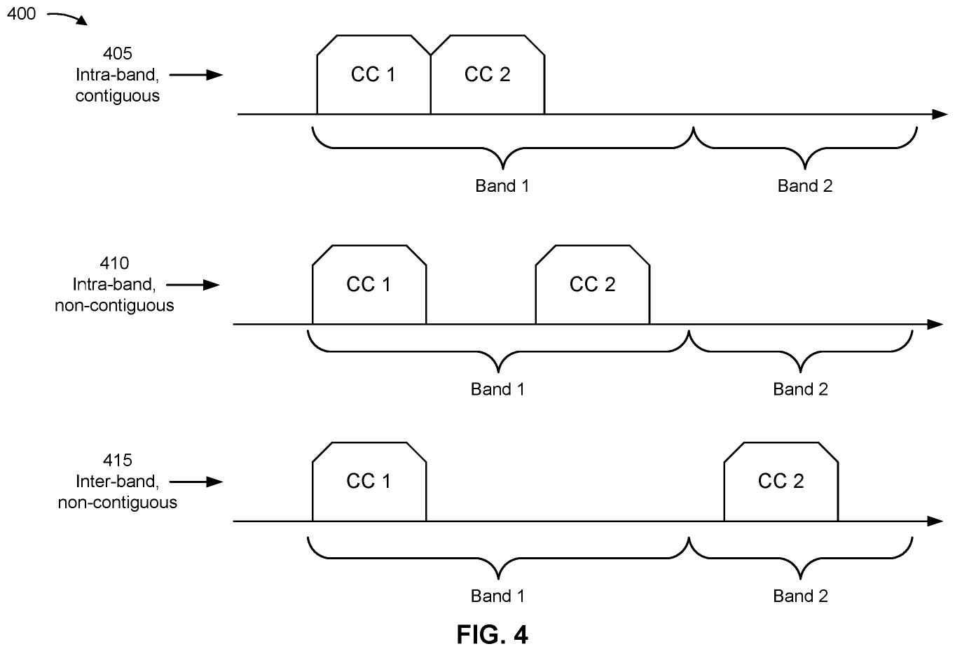

FIG. 4 is a diagram illustrating examples 400 of carrier aggregation, in accordance with the present disclosure.

Carrier aggregation (CA) is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a radio resource control (RRC) message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

Carrier aggregation is one technique, among others, for improving UE throughput and/or reliability. Carrier aggregation includes procedures that are configured to increase a data rate per user by enabling a UE to use concurrent connections to a plurality of cells of a serving network node on a plurality of frequencies. Similarly, dual-connectivity (DC) is a mode of operation in which a UE can be configured to use radio resources of two different schedulers located in two different network nodes (or components of a single network node) connected by a backhaul connection. Dual subscriber information module (SIM) (dual-SIM or DS) is a configuration that enables a UE to connect to a plurality of different network operators' networks (e.g., which may be associated with a corresponding plurality of network nodes or which may be serviced by a single network node with a plurality of different components for the plurality of different network operators).

As indicated above, FIG. 4 is provided as an example. Other examples may differ from what is described with regard to FIG. 4.

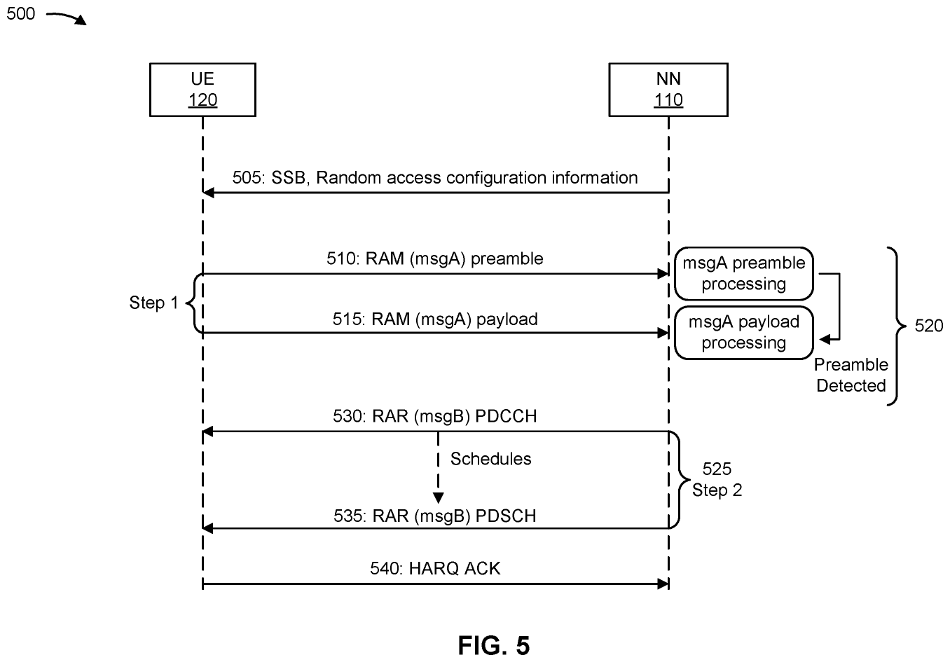

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 510, the UE 120 may transmit, and the network node 110 may receive, a RAM preamble. As shown by reference number 515, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as “message A,” “msgA,” a “first message,” or an “initial message” in a two-step random access procedure. Furthermore, in some aspects, the RAM preamble may be referred to as a “message A preamble,” a “msgA preamble,” a “preamble,” or a “physical random access channel (PRACH) preamble,” and the RAM payload may be referred to as a “message A payload,” a “msgA payload,” or a “payload.” In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

As shown by reference number 520, the network node 110 may receive the RAM preamble transmitted by the UE 120. If the network node 110 successfully receives and decodes the RAM preamble, the network node 110 may then receive and decode the RAM payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as “message B,” “msgB,” or a “second message” in a two-step random access procedure. The RAR message may include some or all of the contents of message 2 (msg2) and message 4 (msg4) of a four-step random access procedure, as described below. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 535, as part of the second step of the two-step random access procedure, the network node 110 may transmit the PDSCH communication for the RAR, as scheduled by the PDCCH communication. The RAR may be included in a medium access control (MAC) protocol data unit (PDU) of the PDSCH communication. As shown by reference number 540, if the UE 120 successfully receives the RAR, the UE 120 may transmit a hybrid automatic repeat request (HARQ) acknowledgement (ACK).

As indicated above, FIG. 5 is provided as an example. Other examples may differ from what is described with regard to FIG. 5.

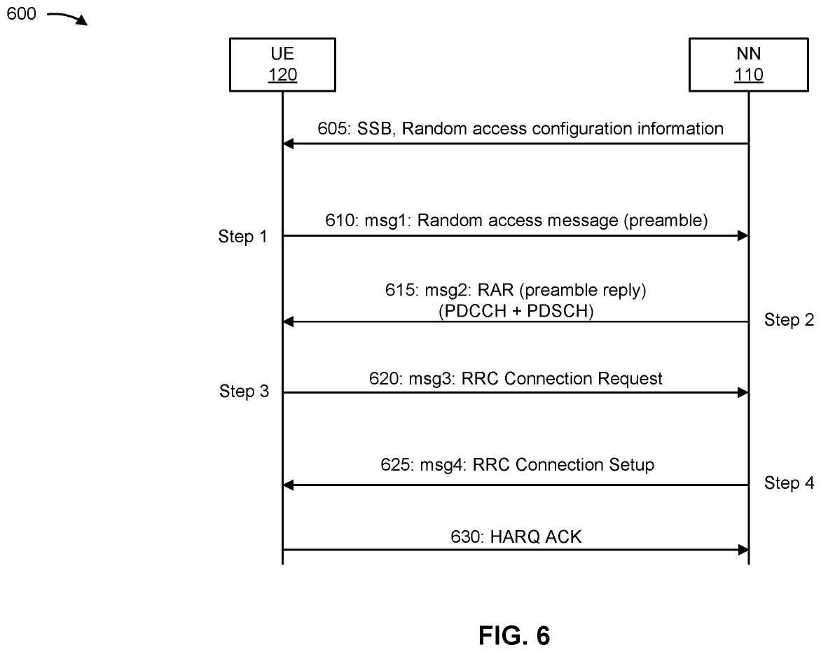

FIG. 6 is a diagram illustrating an example 600 of a four-step random access procedure, in accordance with the present disclosure. As shown in FIG. 6, a network node 110 and a UE 120 may communicate with one another to perform the four-step random access procedure.

As shown by reference number 605, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 610, the UE 120 may transmit a RAM, which may include a preamble (sometimes referred to as a “random access preamble,” a “PRACH preamble,” or a “RAM preamble”). The message that includes the preamble may be referred to as a “message 1,” “msg1,” “MSG1,” a “first message,” or an “initial message” in a four-step random access procedure. The random access message may include a random access preamble identifier.

As shown by reference number 615, the network node 110 may transmit an RAR as a reply to the preamble. The message that includes the RAR may be referred to as “message 2,” “msg2,” “MSG2,” or a “second message” in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 620, the UE 120 may transmit an RRC connection request message. The RRC connection request message may be referred to as “message 3,” “msg3,” “MSG3,” or a “third message” of a four-step random access procedure. In some aspects, the RRC connection request may include a UE identifier, UCI, and/or a PUSCH communication (e.g., an RRC connection request).

As shown by reference number 625, the network node 110 may transmit an RRC connection setup message. The RRC connection setup message may be referred to as “message 4,” “msg4,” “MSG4,” or a “fourth message” of a four-step random access procedure. In some aspects, the RRC connection setup message may include the detected UE identifier, a timing advance value, and/or contention resolution information. As shown by reference number 630, if the UE 120 successfully receives the RRC connection setup message, the UE 120 may transmit a HARQ ACK.

As indicated above, FIG. 6 is provided as an example. Other examples may differ from what is described with regard to FIG. 6.

In some communications systems, a UE can access communication resources across a plurality of different bands to achieve a higher throughput than the UE can achieve in a single band. For example, a UE may be configured for CA, DC, or DS modes, in which the UE can access resources in a set of bands associated with a set of network nodes. Each bandwidth (or band) may be associated with one or more cells, such as a PCell, an SCell, or a PSCell, among other examples. A network node and a UE may initiate a PDCCH ordered PRACH transmission on an SCell to obtain a timing advance (TA) for a secondary timing advance group (sTAG). After a PRACH transmission on the SCell, the UE may be configured to switch to a PCell to monitor for a type-1 PDCCH common search space (CSS) set, to decode an RAR (e.g., if scheduling information for the RAR has been detected), or to transmit a HARQ ACK (e.g., if RAR decoding has been successful).

Resources for random access channel communications may be configured on an SCell or a PCell. However, if the SCell is not a scheduling cell for the UE, the UE may not successfully receive a PDCCH message, from a PCell, that is to trigger the UE to transmit a PRACH communication on the SCell. Additionally, or alternatively, the UE may not be configured to transmit an early report or an assistance information message during a random access procedure to enable a network node to configure energy saving or traffic offloading techniques. Additionally, or alternatively, when random access search space sets and physical uplink control channel (PUCCH) resources associated with one or more SCells are only configured on a PCell, the UE and the network node may lack scheduling flexibility.

Some aspects described herein provide random access procedures for CA, DC, and/or DS scenarios. For example, a network node may configure a UE such that a PCell can be included in either a master cell group (MCG) or a secondary cell group (SCG), and the network node may configure resources on a PCell for a supplementary link or a non-supplementary link. In some aspects, the UE may initiate a random access procedure on an SCell based on receiving a PDCCH from the network node using configured resources. In some aspects, the PDCCH may be associated with downlink control information (DCI) with a particular format for requesting or ordering performing of a random access procedure. In some aspects, a set of triggering events may be configured for causing the UE to initiate the random access procedure. In this way, by providing the random access procedures, the UE and the network node may improve flexibility and may enable use of CA, DC, or DS techniques. By enabling use of CA, DC, or DS techniques, the UE and the network node may improve throughput and/or improve reliability of communications.

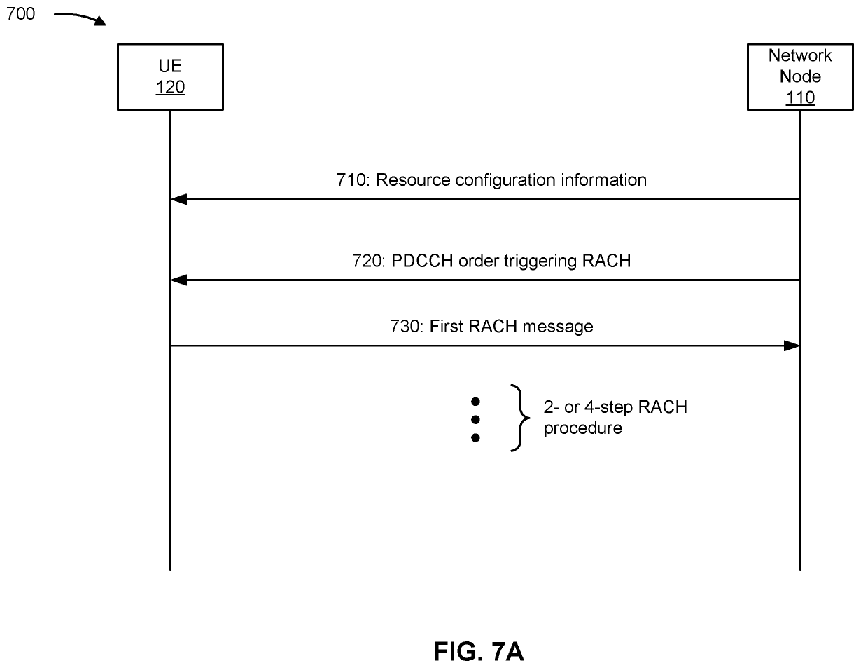

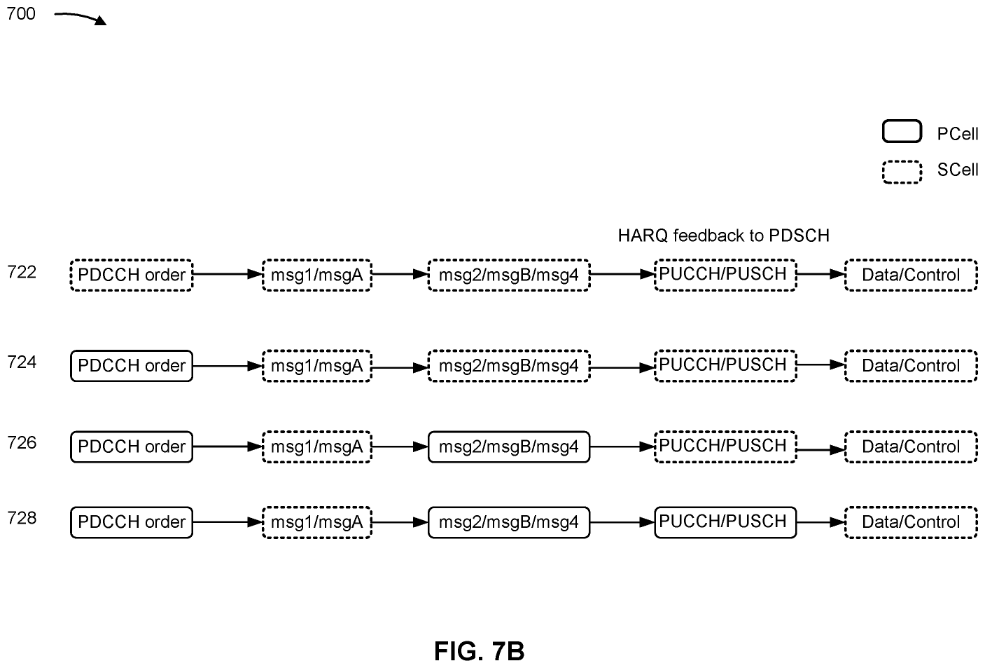

FIGS. 7A and 7B are diagrams illustrating an example 700 associated with random access procedures, in accordance with the present disclosure. As shown in FIG. 7A, example 700 includes communication between a network node 110 and a UE 120.

As further shown in FIG. 7A, and by reference number 710, the UE 120 may receive, from the network node 110, resource configuration information. For example, the UE 120 may receive information identifying a configuration of resources for a PCell (or PSCell) or an SCell. Although some aspects are described herein in terms of receiving a configuration of resources, the configuration of resources may alternatively be specified in a specification or standard.

In some aspects, the UE 120 may receive information identifying random access resources for a random access procedure (e.g., a 2-step or 4-step random access procedure) initiated on a PCell. For example, when a supplementary downlink (SDL) or supplementary uplink (SUL) is configured for a PCell, the UE 120 may receive information indicating that random access resources are configured on the SDL or SUL (e.g., in addition to random access resources configured on a non-supplementary downlink (NDL) or non-supplementary uplink (NUL)). In this case, a random access procedure that is initiated on the PCell in association with the configured random access resources may include a higher layer triggered random access procedure or a PDCCH-ordered triggered random access procedure, as described in more detail herein. Additionally, or alternatively, the UE 120 may receive information identifying a type of random access procedure that can be triggered. For example, the UE 120 may receive information indicating that the UE 120 can be triggered to perform a contention-based random access (CBRA) or contention-free random access (CFRA) procedure. In this case, the CBRA or CFRA procedure may be configured for a PUCCH or a physical uplink shared channel (PUSCH).

In some aspects, the UE 120 may receive information identifying random access resources for a random access procedure initiated on an SCell (e.g., an SCell of an MCG or an SCG). For example, the UE 120 may receive information configuring resources for CBRA or CFRA procedures that can be initiated on the SCell (e.g., by higher layer triggering or PDCCH-ordered triggering, as described in more detail herein). In some aspects, the UE 120 may receive information configuring a PRACH resource for a PDCCH-ordered random access procedure (e.g., a 2-step or 4-step random access procedure) associated with an SCell. For example, the UE 120 may be configured with a resource, on an SCell or a PCell, for receiving a PDCCH order, which triggers the UE 120 to transmit msg1 or msgA of a random access procedure on an SCell. Additionally, or alternatively, the UE 120 may be configured with a PDCCH resource, on an SCell or a PCell, associated with receiving an RAR message or a contention resolution message. Additionally, or alternatively, the UE 120 may be configured with a PUCCH or PUSCH resource for transmitting a HARQ feedback message (e.g., a HARQ ACK) as a response to receiving a PDSCH message (e.g., the RAR message or the contention resolution message). In this case, the PUCCH or PUSCH resource for transmitting the HARQ feedback may be configured on the SCell or the PCell. For example, if the SCell is configured with PDCCH resources associated with RAR reception (e.g., of a 2-step RACH or 4-step RACH message), the UE 120 may be configured with a PUSCH or PUCCH resource on the SCell for transmitting HARQ feedback. Similarly, if the PUSCH or PUCCH resource is configured on the SCell on which the UE 120 initiates the random access procedure (e.g., by transmitting msg1 or msgA), the UE 120 may be configured to reuse transmission parameters (e.g., a transmit beam or power control parameter of msg1 or msgA) for transmitting a PUSCH or PUCCH in the PUSCH or PUCCH resource.

As further shown in FIG. 7A, and by reference number 720, the UE 120 may receive, from the network node 110, a message triggering a random access channel procedure. For example, the UE 120 may receive a PDCCH order (e.g., a PDCCH message conveying downlink control information DCI) that triggers a random access procedure. In some aspects, the UE 120 may receive the PDCCH order on an SCell. For example, as shown in FIG. 7B, and by reference number 722, the UE 120 may receive the PDCCH order in the SCell, which may trigger the UE 120 to initiate the random access procedure on the SCell. Additionally, or alternatively, as shown by reference numbers 724, 726, and 728, the UE 120 may receive the PDCCH order on a PCell, which may trigger the UE 120 to initiate the random access procedure on the SCell.

In some aspects, the UE 120 may receive a PDCCH order conveying DCI with a dedicated DCI format (e.g., that is assigned for a PDCCH ordered random access procedure). For example, the UE 120 may receive DCI that includes a search space configuration, such as a UE-specific search space (USS) or a common search space (CSS) that is configured on a serving cell (e.g., with cross-carrier scheduling or self-scheduling). Additionally, or alternatively, the UE 120 may receive DCI that includes a radio network temporary identifier (RNTI) configuration, such as a UE-specific RNTI (e.g., a cell-specific RNTI (C-RNTI)) or a common RNTI for a group of UEs (e.g., a group-common RNTI (GC-RNTI)), among other examples.

Additionally, or alternatively, the UE 120 may receive DCI that includes a payload with a particular set of indicators. The particular set of indicators may include a priority indicator for the random access procedure (e.g., network assistance information for the UE 120 to perform collision handling and/or transmit power sharing with other communications); a random access type indicator (e.g., to indicate whether 2-step or 4-step random access is triggered, CBRA or CFRA random access is triggered, or self-scheduling or cross-carrier scheduling random access is triggered) for a scheduled cell or transmit and receive point (TRP); a carrier or TRP indicator for cross-carrier scheduling (e.g., an indicator of an identity of a scheduled cell, such as an SCell or a candidate cell for mobility, or of an identity of a TRP associated with msg1 or msgA transmission), which can be used when the PDCCH order is received on a scheduling cell or TRP that is different from the scheduled cell or TRP or can be repurposed when the random access procedure is initiated on the scheduled cell or TRP; a link indicator (e.g., indicating an uplink carrier of a PCell, such as an NUL or SUL, that is associated with msg1 or msgA transmission), which can be repurposed or omitted when the random access procedure is initiated on an SCell; a reference signal indicator (e.g., indicating a beam index of a downlink reference signal, such as a cell-defining synchronization signal block (SSB), a non-cell-defining SSB, or a channel state information reference signal, that is associated with a PRACH resource triggered by the PDCCH order); a PRACH resource indicator (e.g., identifying an index of a PRACH occasion or mask, a PRACH preamble, or a PRACH payload); or a resource allocation indicator (e.g., a frequency domain resource allocation (FDRA) or time domain resource allocation (TDRA), which may be in the form of a fixed bit string hard coded as all ones or all zeros to differentiate from other DCI formats); among other examples.

In some aspects, the PDCCH ordered random access procedure for the UE 120 may be event triggered. For example, to initiate a CFRA or CBRA procedure on an SUL (e.g., for uplink synchronization, measurement reporting, traffic offloading, or coverage enhancement), the UE 120 may receive a PDCCH order on an NDL or SDL or a PCell to trigger transmission of msg1 or msgA on an SUL of the PCell. Additionally, or alternatively, before or during a handover to a target cell or TRP (e.g., for fast radio resource control (RRC) resume or connection; for inter-cell or TRP beam management; timing control; power control; interference management; or measurement reporting), the UE 120 may receive a PDCCH order from a source cell or TRP to trigger the UE 120 to transmit msg1 or msgA on a candidate (e.g., non-serving) cell or TRP. Additionally, or alternatively, to perform a CFRA or CBRA procedure on an SCell in a DC, CA, or DS mode (e.g., for uplink synchronization, measurement reporting, traffic offloading, or interference management), the UE 120 may receive a PDCCH order from a scheduling SCell or a PCell to trigger the UE 120 to transmit msg1 or msgA on the SCell.

As further shown in FIG. 7A, and by reference number 730, the UE 120 may transmit, to the network node 110, a first random access message, which may initiate a random access procedure and result in transmission or reception of one or more further random access messages (e.g., an RAR, HARQ feedback, or another message). For example, the UE 120 may transmit a msg1 or msgA of a 4-step or 2-step RACH procedure, respectively. As shown in FIG. 7B, the UE 120 may transmit the first random access message on an SCell. As a response to the first random access message, which initiates a random access procedure, the UE 120 may receive a second random access message. For example, as shown by reference numbers 722 and 724, the UE 120 may receive a msg2 (and subsequent msg4) or a msgB (e.g., via a PDSCH) on an SCell, transmit HARQ feedback (e.g., via a PUCCH or PUSCH) on the SCell, and receive data or control information on the SCell as a response to transmitting the HARQ feedback. Similarly, as shown by reference number 726, the UE 120 may receive the msg2 (and subsequent msg4) or the msgB (e.g., via a PDSCH) on a PCell, transmit HARQ feedback (e.g., via a PUCCH or PUSCH) on the SCell, and receive data or control information on the SCell as a response to transmitting the HARQ feedback. Similarly, as shown by reference number 728, the UE 120 may receive the msg2 (and subsequent msg4) or the msgB (e.g., via a PDSCH) on a PCell, transmit HARQ feedback (e.g., via a PUCCH or PUSCH) on the PCell, and receive data or control information on the SCell as a response to transmitting the HARQ feedback.

As indicated above, FIGS. 7A and 7B are provided as an example. Other examples may differ from what is described with respect to FIGS. 7A and 7B.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with performing random access procedures.

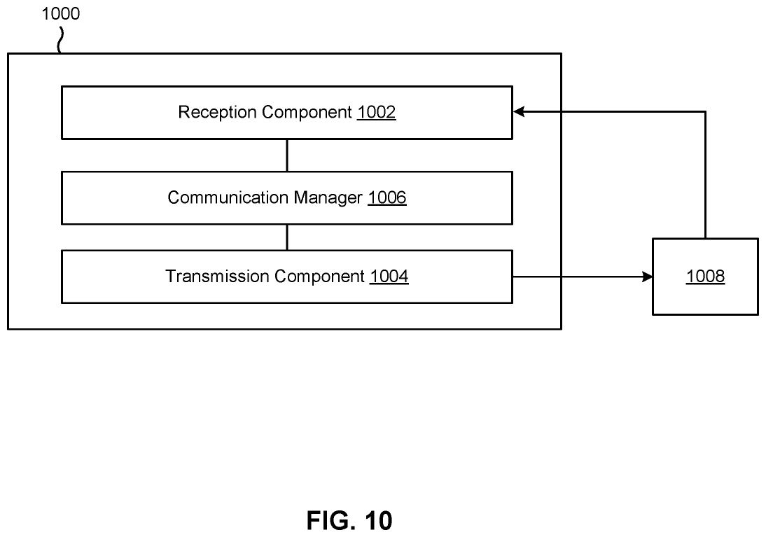

As shown in FIG. 8, in some aspects, process 800 may include receiving a PDCCH message indicating initiation of a random access procedure, the PDCCH message having a dedicated format with a set of fields for indicating one or more parameters associated with the initiation of the random access procedure (block 810). For example, the UE (e.g., using reception component 1002 and/or communication manager 1006, depicted in FIG. 10) may receive a PDCCH message indicating initiation of a random access procedure, the PDCCH message having a dedicated format with a set of fields for indicating one or more parameters associated with the initiation of the random access procedure, as described above.

As further shown in FIG. 8, in some aspects, process 800 may include transmitting a first random access message of the random access procedure, the first random access message being associated with the one or more parameters (block 820). For example, the UE (e.g., using transmission component 1004 and/or communication manager 1006, depicted in FIG. 10) May transmit a first random access message of the random access procedure, the first random access message being associated with the one or more parameters, as described above.

Process 800 may include additional aspects, such as any single aspect or any combination of aspects described below and/or in connection with one or more other processes described elsewhere herein.

In a first aspect, the random access procedure is a 4-step random access procedure or a 2-step random access procedure, wherein the random access procedure is initiated on a primary cell or a secondary cell, wherein the PDCCH triggers the random access procedure of one or more UEs, and wherein the random access procedure is a contention-based random access procedure or a contention-free random access procedure.

In a second aspect, alone or in combination with the first aspect, a supplementary link is configured on a carrier frequency different from a primary cell associated with carrier aggregation or multiple connectivity, and one or more random access resources associated with uplink or downlink communication of the random access procedure are configured on the supplementary link.

In a third aspect, alone or in combination with one or more of the first and second aspects, process 800 includes transmitting, on an uplink control channel or a data channel, a HARQ feedback as a response to receiving a random access response message or contention resolution message associated with the random access procedure, wherein the uplink control channel or data channel is configured on a cell for which the UE initiates the random access procedure, or a cell that is configured with a valid uplink control resource associated with a HARQ procedure and that is different from the cell for which the UE initiates the random access procedure.

In a fourth aspect, alone or in combination with one or more of the first through third aspects, a secondary cell associated with carrier aggregation or multiple connectivity is configured with a first set of resources associated with receiving a random access response message or a contention resolution message of the random access procedure, and the secondary cell is configured with a second set of resources for transmitting an uplink control channel or data channel communication in connection with the random access procedure.

In a fifth aspect, alone or in combination with one or more of the first through fourth aspects, a plurality of communications on a secondary cell, in connection with the random access procedure, share a common set of beam parameters configured for the secondary cell.

In a sixth aspect, alone or in combination with one or more of the first through fifth aspects, the one or more parameters include a parameter relating to at least one of a UE-specific or common search space set configuration, a UE-specific or group-common radio network temporary identifier configuration, a downlink control information payload configuration, a priority indicator for the random access procedure, a random access procedure type indicator, a carrier indicator, a link type indicator, a downlink or uplink reference signal indicator, a power control parameter, a resource indicator for a sequence, a time or frequency occasion of a preamble, or a resource allocation indicator for a data channel in a time or frequency domain.

In a seventh aspect, alone or in combination with one or more of the first through sixth aspects, the PDCCH message is received on a supplementary link or a non-supplementary link of a primary cell associated with carrier aggregation or multiple connectivity.

In an eighth aspect, alone or in combination with one or more of the first through seventh aspects, the PDCCH message is received from a source cell or TRP associated with a mobility procedure.

In a ninth aspect, alone or in combination with one or more of the first through eighth aspects, the PDCCH message is received from a scheduling secondary cell or a scheduling primary cell associated with carrier aggregation or multiple connectivity.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with random access procedures.

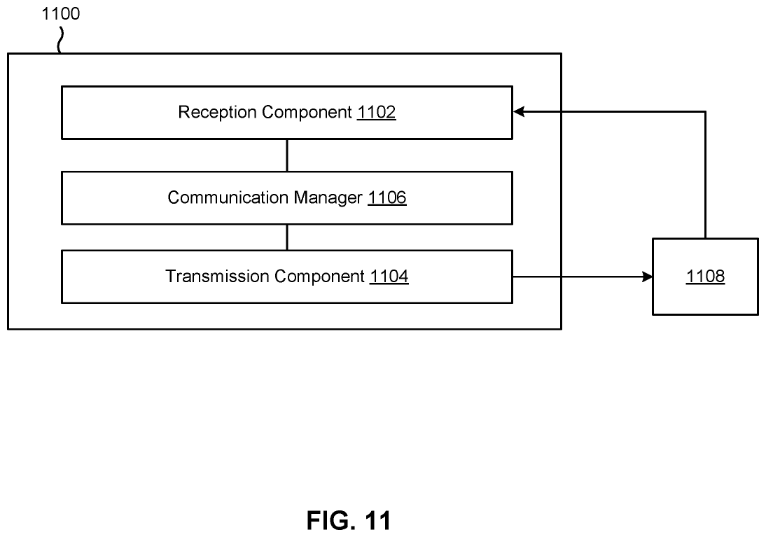

As shown in FIG. 9, in some aspects, process 900 may include transmitting a PDCCH message indicating initiation of a random access procedure, the PDCCH message having a dedicated format with a set of fields for indicating one or more parameters associated with the initiation of the random access procedure (block 910). For example, the network node (e.g., using transmission component 1104 and/or communication manager 1106, depicted in FIG. 11) may transmit a PDCCH message indicating initiation of a random access procedure, the PDCCH message having a dedicated format with a set of fields for indicating one or more parameters associated with the initiation of the random access procedure, as described above.

As further shown in FIG. 9, in some aspects, process 900 may include receiving a first random access message of the random access procedure, the first random access message being associated with the one or more parameters (block 920). For example, the network node (e.g., using reception component 1102 and/or communication manager 1106, depicted in FIG. 11) may receive a first random access message of the random access procedure, the first random access message being associated with the one or more parameters, as described above.

Process 900 may include additional aspects, such as any single aspect or any combination of aspects described below and/or in connection with one or more other processes described elsewhere herein.

In a first aspect, the random access procedure is a 4-step random access procedure or a 2-step random access procedure, wherein the random access procedure is initiated on a primary cell or a secondary cell, wherein the PDCCH triggers the random access procedure of one or more UEs, and wherein the random access procedure is a contention-based random access procedure or a contention-free random access procedure.

In a second aspect, alone or in combination with the first aspect, a supplementary link is configured on a carrier frequency different from a primary cell associated with carrier aggregation or multiple connectivity, and one or more random access resources associated with uplink or downlink communication of the random access procedure are configured on the supplementary link.

In a third aspect, alone or in combination with one or more of the first and second aspects, process 900 includes receiving, on an uplink control channel or a data channel, a HARQ feedback as a response to transmitting a random access response message or contention resolution message associated with the random access procedure, wherein the uplink control channel or data channel is configured on a cell for which a UE initiates the random access procedure, or a cell that is configured with a valid uplink control resource associated with a HARQ procedure and that is different from the cell for which the UE initiates the random access procedure.

In a fourth aspect, alone or in combination with one or more of the first through third aspects, a secondary cell associated with carrier aggregation or multiple connectivity is configured with a first set of resources associated with transmitting a random access response message or a contention resolution message of the random access procedure, and the secondary cell is configured with a second set of resources for transmitting an uplink control channel or data channel communication in connection with the random access procedure.

In a fifth aspect, alone or in combination with one or more of the first through fourth aspects, a plurality of communications on a secondary cell, in connection with the random access procedure, share a common set of beam parameters configured for the secondary cell.

In a sixth aspect, alone or in combination with one or more of the first through fifth aspects, the one or more parameters include a parameter relating to at least one of a UE-specific or common search space set configuration, a UE-specific or group-common radio network temporary identifier configuration, a downlink control information payload configuration, a priority indicator for the random access procedure, a random access procedure type indicator, a carrier indicator, a link type indicator, a downlink or uplink reference signal indicator, a power control parameter, a resource indicator for a sequence, a time or frequency occasion of a preamble, or a resource allocation indicator for a data channel in a time or frequency domain.

In a seventh aspect, alone or in combination with one or more of the first through sixth aspects, the PDCCH message is transmitted on a supplementary link or a non-supplementary link of a primary cell associated with carrier aggregation or multiple connectivity.

In an eighth aspect, alone or in combination with one or more of the first through seventh aspects, the PDCCH message is transmitted on a source cell or TRP associated with a mobility procedure.

In a ninth aspect, alone or in combination with one or more of the first through eighth aspects, the PDCCH message is transmitted on a scheduling secondary cell or a scheduling primary cell associated with carrier aggregation or multiple connectivity.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7A-7B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a PDCCH message indicating initiation of a random access procedure, the PDCCH message having a dedicated format with a set of fields for indicating one or more parameters associated with the initiation of the random access procedure. The transmission component 1004 may transmit a first random access message of the random access procedure, the first random access message being associated with the one or more parameters.

The transmission component 1004 may transmit, on an uplink control channel or a data channel, a HARQ feedback as a response to receiving a random access response message or contention resolution message associated with the random access procedure, wherein the uplink control channel or data channel is configured on a cell for which the UE initiates the random access procedure, or a cell that is configured with a valid uplink control resource associated with a HARQ procedure and that is different from the cell for which the UE initiates the random access procedure.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a PDCCH message indicating initiation of a random access procedure, the PDCCH message having a dedicated format with a set of fields for indicating one or more parameters associated with the initiation of the random access procedure. The reception component 1102 may receive a first random access message of the random access procedure, the first random access message being associated with the one or more parameters.

The reception component 1102 may receive, on an uplink control channel or a data channel, a HARQ feedback as a response to transmitting a random access response message or contention resolution message associated with the random access procedure, wherein the uplink control channel or data channel is configured on a cell for which a UE initiates the random access procedure, or a cell that is configured with a valid uplink control resource associated with a HARQ procedure and that is different from the cell for which the UE initiates the random access procedure.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a physical downlink control channel (PDCCH) message indicating initiation of a random access procedure, the PDCCH message having a dedicated format with a set of fields for indicating one or more parameters associated with the initiation of the random access procedure; and transmitting a first random access message of the random access procedure, the first random access message being associated with the one or more parameters.

Aspect 2: The method of Aspect 1, wherein the random access procedure is a 4-step random access procedure or a 2-step random access procedure, wherein the random access procedure is initiated on a primary cell or a secondary cell, wherein the PDCCH triggers the random access procedure of one or more UEs, and wherein the random access procedure is a contention-based random access procedure or a contention-free random access procedure.

Aspect 3: The method of any of Aspects 1-2, wherein a supplementary link is configured on a carrier frequency different from a primary cell associated with carrier aggregation or multiple connectivity, and wherein one or more random access resources associated with uplink or downlink communication of the random access procedure are configured on the supplementary link.

Aspect 4: The method of any of Aspects 1-3, further comprising: transmitting, on an uplink control channel or a data channel, a hybrid automatic repeat request (HARQ) feedback as a response to receiving a random access response message or contention resolution message associated with the random access procedure, wherein the uplink control channel or data channel is configured on: a cell for which the UE initiates the random access procedure, or a cell that is configured with a valid uplink control resource associated with a HARQ procedure and that is different from the cell for which the UE initiates the random access procedure.

Aspect 5: The method of any of Aspects 1-4, wherein a secondary cell associated with carrier aggregation or multiple connectivity is configured with a first set of resources associated with receiving a random access response message or a contention resolution message of the random access procedure, and wherein the secondary cell is configured with a second set of resources for transmitting an uplink control channel or data channel communication in connection with the random access procedure.

Aspect 6: The method of any of Aspects 1-5, wherein a plurality of communications on a secondary cell, in connection with the random access procedure, share a common set of beam parameters configured for the secondary cell.

Aspect 7: The method of any of Aspects 1-6, wherein the one or more parameters include a parameter relating to at least one of: a UE-specific or common search space set configuration, a UE-specific or group-common radio network temporary identifier configuration, a downlink control information payload configuration, a priority indicator for the random access procedure, a random access procedure type indicator, a carrier indicator, a link type indicator, a downlink or uplink reference signal indicator, a power control parameter, a resource indicator for a sequence, a time or frequency occasion of a preamble, or a resource allocation indicator for a data channel in a time or frequency domain.

Aspect 8: The method of any of Aspects 1-7, wherein the PDCCH message is received on a supplementary link or a non-supplementary link of a primary cell associated with carrier aggregation or multiple connectivity.

Aspect 9: The method of any of Aspects 1-8, wherein the PDCCH message is received from a source cell or transmit and receive point (TRP) associated with a mobility procedure.

Aspect 10: The method of any of Aspects 1-9, wherein the PDCCH message is received from a scheduling secondary cell or a scheduling primary cell associated with carrier aggregation or multiple connectivity.

Aspect 11: A method of wireless communication performed by a network node, comprising: transmitting a physical downlink control channel (PDCCH) message indicating initiation of a random access procedure, the PDCCH message having a dedicated format with a set of fields for indicating one or more parameters associated with the initiation of the random access procedure; and receiving a first random access message of the random access procedure, the first random access message being associated with the one or more parameters.

Aspect 12: The method of Aspect 11, wherein the random access procedure is a 4-step random access procedure or a 2-step random access procedure, wherein the random access procedure is initiated on a primary cell or a secondary cell, wherein the PDCCH triggers the random access procedure of one or more user equipment, and wherein the random access procedure is a contention-based random access procedure or a contention-free random access procedure.

Aspect 13: The method of any of Aspects 11-12, wherein a supplementary link is configured on a carrier frequency different from a primary cell associated with carrier aggregation or multiple connectivity, and wherein one or more random access resources associated with uplink or downlink communication of the random access procedure are configured on the supplementary link.

Aspect 14: The method of any of Aspects 11-13, further comprising: receiving, on an uplink control channel or a data channel, a hybrid automatic repeat request (HARQ) feedback as a response to transmitting a random access response message or contention resolution message associated with the random access procedure, wherein the uplink control channel or data channel is configured on: a cell for which a user equipment initiates the random access procedure, or a cell that is configured with a valid uplink control resource associated with a HARQ procedure and that is different from the cell for which the user equipment initiates the random access procedure.

Aspect 15: The method of any of Aspects 11-14, wherein a secondary cell associated with carrier aggregation or multiple connectivity is configured with a first set of resources associated with transmitting a random access response message or a contention resolution message of the random access procedure, and wherein the secondary cell is configured with a second set of resources for transmitting an uplink control channel or data channel communication in connection with the random access procedure.

Aspect 16: The method of any of Aspects 11-15, wherein a plurality of communications on a secondary cell, in connection with the random access procedure, share a common set of beam parameters configured for the secondary cell.

Aspect 17: The method of any of Aspects 11-16, wherein the one or more parameters include a parameter relating to at least one of: a user equipment-specific or common search space set configuration, a user equipment-specific or group-common radio network temporary identifier configuration, a downlink control information payload configuration, a priority indicator for the random access procedure, a random access procedure type indicator, a carrier indicator, a link type indicator, a downlink or uplink reference signal indicator, a power control parameter, a resource indicator for a sequence, a time or frequency occasion of a preamble, or a resource allocation indicator for a data channel in a time or frequency domain.

Aspect 18: The method of any of Aspects 11-17, wherein the PDCCH message is transmitted on a supplementary link or a non-supplementary link of a primary cell associated with carrier aggregation or multiple connectivity.

Aspect 19: The method of any of Aspects 11-18, wherein the PDCCH message is transmitted on a source cell or transmit and receive point (TRP) associated with a mobility procedure.

Aspect 20: The method of any of Aspects 11-19, wherein the PDCCH message is transmitted on a scheduling secondary cell or a scheduling primary cell associated with carrier aggregation or multiple connectivity.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, individually or collectively configured to cause the UE to:
receive a physical downlink control channel (PDCCH) message indicating initiation of a random access procedure, the PDCCH message having a dedicated format with a set of fields for indicating one or more parameters associated with the initiation of the random access procedure; and
transmit a first random access message of the random access procedure, the first random access message being associated with the one or more parameters.

2. The UE of claim 1, wherein the random access procedure is a 4-step random access procedure or a 2-step random access procedure,
wherein the random access procedure is initiated on a primary cell or a secondary cell, wherein the PDCCH triggers the random access procedure of one or more UEs, and wherein the random access procedure is a contention-based random access procedure or a contention-free random access procedure.

3. The UE of claim 1, wherein a supplementary link is configured on a carrier frequency different from a primary cell associated with carrier aggregation or multiple connectivity, and wherein one or more random access resources associated with uplink or downlink communication of the random access procedure are configured on the supplementary link.

4. The UE of claim 1, wherein the one or more processors, individually or collectively, are further configured to cause the UE to:
transmit, on an uplink control channel or a data channel, a hybrid automatic repeat request (HARQ) feedback as a response to receiving a random access response message or contention resolution message associated with the random access procedure, wherein the uplink control channel or data channel is configured on:
a cell for which the UE initiates the random access procedure, or
a cell that is configured with a valid uplink control resource associated with a HARQ procedure and that is different from the cell for which the UE initiates the random access procedure.

5. The UE of claim 1, wherein a secondary cell associated with carrier aggregation or multiple connectivity is configured with a first set of resources associated with receiving a random access response message or a contention resolution message of the random access procedure, and
wherein the secondary cell is configured with a second set of resources for transmitting an uplink control channel or data channel communication in connection with the random access procedure.

6. The UE of claim 1, wherein a plurality of communications on a secondary cell, in connection with the random access procedure, share a common set of beam parameters configured for the secondary cell.

7. The UE of claim 1, wherein the one or more parameters include a parameter relating to at least one of:
a UE-specific or common search space set configuration,
a UE-specific or group-common radio network temporary identifier configuration,
a downlink control information payload configuration,
a priority indicator for the random access procedure,
a random access procedure type indicator,
a carrier indicator,
a link type indicator,
a downlink or uplink reference signal indicator,
a power control parameter,
a resource indicator for a sequence,
a time or frequency occasion of a preamble, or
a resource allocation indicator for a data channel in a time or frequency domain.

8. The UE of claim 1, wherein the PDCCH message is received on a supplementary link or a non-supplementary link of a primary cell associated with carrier aggregation or multiple connectivity.

9. The UE of claim 1, wherein the PDCCH message is received from a source cell or transmit and receive point (TRP) associated with a mobility procedure.

10. The UE of claim 1, wherein the PDCCH message is received from a scheduling secondary cell or a scheduling primary cell associated with carrier aggregation or multiple connectivity.

11. A network node for wireless communication, comprising:
one or more memories; and
one or more processors, coupled to the one or more memories, individually or collectively configured to cause the network node to:
transmit a physical downlink control channel (PDCCH) message indicating initiation of a random access procedure, the PDCCH message having a dedicated format with a set of fields for indicating one or more parameters associated with the initiation of the random access procedure; and
receive a first random access message of the random access procedure, the first random access message being associated with the one or more parameters.

12. The network node of claim 11, wherein the random access procedure is a 4-step random access procedure or a 2-step random access procedure,
wherein the random access procedure is initiated on a primary cell or a secondary cell, wherein the PDCCH triggers the random access procedure of one or more user equipment, and wherein the random access procedure is a contention-based random access procedure or a contention-free random access procedure.

13. The network node of claim 11, wherein a supplementary link is configured on a carrier frequency different from a primary cell associated with carrier aggregation or multiple connectivity, and wherein one or more random access resources associated with uplink or downlink communication of the random access procedure are configured on the supplementary link.

14. The network node of claim 11, wherein the one or more processors, individually or collectively, are further configured to cause the network node to:
receive, on an uplink control channel or a data channel, a hybrid automatic repeat request (HARQ) feedback as a response to transmitting a random access response message or contention resolution message associated with the random access procedure, wherein the uplink control channel or data channel is configured on:
a cell for which a user equipment initiates the random access procedure, or
a cell that is configured with a valid uplink control resource associated with a HARQ procedure and that is different from the cell for which the user equipment initiates the random access procedure.

15. The network node of claim 11, wherein a secondary cell associated with carrier aggregation or multiple connectivity is configured with a first set of resources associated with transmitting a random access response message or a contention resolution message of the random access procedure, and
wherein the secondary cell is configured with a second set of resources for transmitting an uplink control channel or data channel communication in connection with the random access procedure.

16. The network node of claim 11, wherein a plurality of communications on a secondary cell, in connection with the random access procedure, share a common set of beam parameters configured for the secondary cell.

17. The network node of claim 11, wherein the one or more parameters include a parameter relating to at least one of:
a user equipment-specific or common search space set configuration,
a user equipment-specific or group-common radio network temporary identifier configuration,
a downlink control information payload configuration,
a priority indicator for the random access procedure,
a random access procedure type indicator,
a carrier indicator,
a link type indicator,
a downlink or uplink reference signal indicator,
a power control parameter,
a resource indicator for a sequence,
a time or frequency occasion of a preamble, or
a resource allocation indicator for a data channel in a time or frequency domain.

18. The network node of claim 11, wherein the PDCCH message is transmitted on a supplementary link or a non-supplementary link of a primary cell associated with carrier aggregation or multiple connectivity.

19. The network node of claim 11, wherein the PDCCH message is transmitted on a source cell or transmit and receive point (TRP) associated with a mobility procedure.

20. The network node of claim 11, wherein the PDCCH message is transmitted on a scheduling secondary cell or a scheduling primary cell associated with carrier aggregation or multiple connectivity.

21. A method of wireless communication performed by a user equipment (UE), comprising:
receiving a physical downlink control channel (PDCCH) message indicating initiation of a random access procedure, the PDCCH message having a dedicated format with a set of fields for indicating one or more parameters associated with the initiation of the random access procedure; and
transmitting a first random access message of the random access procedure, the first random access message being associated with the one or more parameters.

22. The method of claim 21, wherein the random access procedure is a 4-step random access procedure or a 2-step random access procedure,
wherein the random access procedure is initiated on a primary cell or a secondary cell, wherein the PDCCH triggers the random access procedure of one or more UEs, and wherein the random access procedure is a contention-based random access procedure or a contention-free random access procedure.

23. The method of claim 21, wherein a supplementary link is configured on a carrier frequency different from a primary cell associated with carrier aggregation or multiple connectivity, and wherein one or more random access resources associated with uplink or downlink communication of the random access procedure are configured on the supplementary link.

24. The method of claim 21, further comprising:
transmitting, on an uplink control channel or a data channel, a hybrid automatic repeat request (HARQ) feedback as a response to receiving a random access response message or contention resolution message associated with the random access procedure, wherein the uplink control channel or data channel is configured on:
a cell for which the UE initiates the random access procedure, or
a cell that is configured with a valid uplink control resource associated with a HARQ procedure and that is different from the cell for which the UE initiates the random access procedure.

25. The method of claim 21, wherein a secondary cell associated with carrier aggregation or multiple connectivity is configured with a first set of resources associated with receiving a random access response message or a contention resolution message of the random access procedure, and
wherein the secondary cell is configured with a second set of resources for transmitting an uplink control channel or data channel communication in connection with the random access procedure.

26. The method of claim 21, wherein a plurality of communications on a secondary cell, in connection with the random access procedure, share a common set of beam parameters configured for the secondary cell.

27. The method of claim 21, wherein the one or more parameters include a parameter relating to at least one of:
a UE-specific or common search space set configuration,
a UE-specific or group-common radio network temporary identifier configuration,
a downlink control information payload configuration,
a priority indicator for the random access procedure,
a random access procedure type indicator,
a carrier indicator,
a link type indicator,
a downlink or uplink reference signal indicator,
a power control parameter,
a resource indicator for a sequence,
a time or frequency occasion of a preamble, or
a resource allocation indicator for a data channel in a time or frequency domain.

28. The method of claim 21, wherein the PDCCH message is received on a supplementary link or a non-supplementary link of a primary cell associated with carrier aggregation or multiple connectivity.

29. A method of wireless communication performed by a network node, comprising:
transmitting a physical downlink control channel (PDCCH) message indicating initiation of a random access procedure, the PDCCH message having a dedicated format with a set of fields for indicating one or more parameters associated with the initiation of the random access procedure; and
receiving a first random access message of the random access procedure, the first random access message being associated with the one or more parameters.

30. The method of claim 29, wherein the random access procedure is a 4-step random access procedure or a 2-step random access procedure,
wherein the random access procedure is initiated on a primary cell or a secondary cell, wherein the PDCCH triggers the random access procedure of one or more user equipment, and wherein the random access procedure is a contention-based random access procedure or a contention-free random access procedure.
